(19) United States
(12) Patent Application Publication
(10) Pub. No.: US 2020/0032816 A1
(43) Pub. Date: Jan. 30, 2020

(54) STRUCTURAL ASSEMBLY FOR A COMPRESSOR OF A FLUID FLOW MACHINE

(71) Applicant: Rolls-Royce Deutschland Ltd & Co KG, Blankenfelde-Mahlow (DE)

(72) Inventors: Frank HEINICHEN, Berlin (DE); Ali Can CIVELEK, Berlin (DE)

(21) Appl. No.: 16/513,144

(22) Filed: Jul. 16, 2019

(30) Foreign Application Priority Data
Jul. 24, 2018 (DE) 10 2018 117 884.0

(51) Int. Cl. F04D 29/54; F01D 17/16

(52) U.S. Cl. CPC F04D 29/544; F05D 2250/20; F05D 2240/12; F01D 17/162

(57) ABSTRACT

A structural subassembly for a compressor of a turbomachine, which has: a stator with a multiplicity of guide blades which extend in a flow path of the turbomachine, wherein the guide blades have an axis of rotation and are designed to be adjustable in terms of their stagger angle; an inner flow path boundary, which delimits the flow path through the turbomachine radially at the inside; and an outer flow path boundary, which delimits the flow path through the turbomachine radially at the outside. Here, the guide blades have first partial gaps with respect to the outer flow path boundary and/or second partial gaps with respect to the inner flow path boundary. Provision is made whereby the guide blades are arranged and formed such that the axes of rotation of the guide blades have a combined inclination both with respect to the axial direction and in a circumferential direction.

This application claims priority to German Patent Application DE102018117884.0 filed Jul. 24, 2018, the entirety of which is incorporated by reference herein.

The invention relates to a structural subassembly for a compressor of a turbomachine as per the preamble of Patent claim 1.

Compressors of aircraft engines are designed for a particular design rotational speed. In the part-load range, that is to say at rotational speeds lower than the design rotational speed, there is the risk of local flow separation at the rotor blades of the compressor cascade. To expand the stable working range, it is known for stators with variable stagger angles to be used in multi-stage axial compressors. To realize adequate operational reliability, it is furthermore known for such variable stators to be formed with partial gaps which run between the blade airfoil and the adjacent flow path boundary. Such partial gaps are also referred to as “cut-back” or “clipping”. However, the resulting gap flow leads to flow losses, which have an adverse effect on the efficiency of the compressor and can lead to increased vibration amplitudes at rotors arranged downstream.

The present invention is based on the object of providing a structural subassembly for a compressor of a turbomachine with improved aerodynamic characteristics.

This object is achieved by a structural subassembly having the features of claim 1. Design embodiments of the invention are set forth in the dependent claims.

Accordingly, the invention relates to a structural subassembly for a compressor of a turbomachine, which has a stator with a multiplicity of guide blades which extend in a flow path of the turbomachine, wherein the guide blades have an axis of rotation and are designed to be adjustable in terms of their stagger angle. The structural subassembly comprises an inner flow path boundary, which delimits the flow path through the turbomachine radially at the inside, and an outer flow path boundary, which delimits the flow path through the turbomachine radially at the outside. Here, the guide blades form first partial gaps with respect to the outer flow path boundary and/or second partial gaps with respect to the inner flow path boundary.

The radially inner flow path boundary is provided for example by a hub of the compressor, and the outer flow path boundary by a compressor casing. It is pointed out that the partial gaps are, owing to the rotatability of the guide blades, formed adjacent to the flow path boundary out of necessity, and the existence thereof permits a rotation or change in the stagger angle in the first place, because, without such partial gaps, contact or a collision with the flow path boundary would occur in the event of a change of the stagger angle. Here, the greater the degree to which the flow path boundary locally changes (in an axial direction and/or in a circumferential direction) in the region of the stator, for example owing to a downwardly sloping inner annulus contour, the larger the partial gaps have to be formed.

The gaps are referred to as partial gaps because they extend not over the entire axial length of the guide blades, but only over a partial length.

The invention provides for the guide blades to be arranged and formed such that the axes of rotation of the guide blades have a combined inclination both with respect to the axial direction and in a circumferential direction. By means of a combined inclination of the stator axis of rotation both with respect to the axial direction and in the circumferential direction, it is made possible for the partial gaps to be selected to be narrow, and minimized, in relation to the adjacent flow path boundary at least in a partial range of the adjustable stagger angle. Thus, with the inclination of the axes of rotation in the circumferential direction and with the inclination of the axes of rotation with respect to the axial direction, two design parameters are provided which make it possible for the spacing to the adjacent flow path boundary to be minimized at least in certain portions. In this way, it is possible to achieve improvements in terms of efficiency, stability and vibration level.

It is pointed out that the inclination of the respective axis of rotation of the guide blades in the structural subassembly is, as a design parameter, fixed and non-variable. Only the stagger angle is variable. The combined inclination of the axes of rotation of the guide blades both with respect to the axial direction and in the circumferential direction is thus a structurally fixed inclination in the structural subassembly.

Here, the present invention has the effect that the inwardly directed elongations of the axes of rotation of the guide blades of the stator do not intersect at a point of the stator axis, as would be the case if the axes of rotation of the guide blades of the stator were all to extend exactly in the radial direction (in a cylindrical coordinate system). Instead, the axes of rotation of the guide blades of the stator are inclined in the circumferential direction such that the respective radially inwardly directed elongations thereof lie tangentially on an imaginary circle which extends around the stator axis in a section plane perpendicular to the stator axis.

The exact combinations of the two inclination parameters are dependent on a multiplicity of variables. These include the annulus inclination angle (that is to say the deviation of the course of the annular space formed by the radially inner flow path boundary and the radially outer flow path boundary from a course exactly in an axial direction), the annulus curvature in the circumferential direction, and the adjustment range of the variable stator.

One embodiment of the invention provides for the inclination of the axes of rotation of the guide blades both with respect to the axial direction and in the circumferential direction to be optimized such that a predefined minimum gap is not undershot in the first partial gap and/or in the second partial gap in the case of all settable stagger angles, that is to say over the entire adjustment range. In one embodiment, this applies both to the first partial gap and to the second partial gap, that is to say a first radially outer minimum gap is not undershot with regard to the first partial gap, and a second radially inner minimum gap is not undershot with regard to the second partial gap. In this regard, the inclination of the axes of rotation follows a predefined set of design rules, which may be provided for example by means of an optimization program.

Here, provision may be made whereby the inclination of the axes of rotation is optimized such that the first partial gap and/or the second partial gap maintains a minimum spacing to the adjacent flow path boundary, that is to say does not change, or changes only insignificantly, in the event of a change of the stagger angle, over the entire adjustment range.

In exemplary embodiments, provision may be made whereby the axes of rotation are inclined in a positive direction in the circumferential direction, wherein the positive direction is defined as being clockwise in a view from the front. Alternatively, the axes of rotation may be inclined in a negative direction (counter to the circumferential direction). The wording “inclined in the circumferential direction” is to be understood to mean that it encompasses both variants. The inclinations in the circumferential direction may thus be both counter to or in the direction of rotation of the rotor arranged downstream of the stator. Here, the axes of rotation are for example tilted in the circumferential direction or counter to the circumferential direction by a tilt angle in the range between 0° and ±10°, that is to say deviate from an exactly radial extent by said angle.

In further exemplary embodiments, provision may be made for the axes of rotation to be inclined upstream with respect to the axial direction. Alternatively, the axes of rotation may be inclined downstream with respect to the axial direction. The axial direction is defined here as the direction pointing from the engine inlet to the engine outlet. The statement that the axis of rotation of a guide blade is inclined upstream with respect to the axial direction means that the axis of rotation is inclined upstream counter to the axial direction, and here, encloses an angle of less than 90° with the stator axis or the machine axis of the engine. The statement that the axis of rotation of a guide blade is inclined downstream with respect to the axial direction means that the axis of rotation is inclined downstream in the axial direction, and here, encloses an angle of less than 90° with the axis of rotation of the guide blade or the machine axis of the engine.

For example, the axes of rotation are tilted by a tilt angle in the range between 0° and ±10° with respect to the axial direction. Here, the tilt angle is defined in the meridional section as the angle between the exactly radial direction and the direction, inclined with respect to the axial direction, of the axis of rotation.

One embodiment of the invention provides for the partial gaps to be formed in the region of the leading edge and/or in the region of the trailing edge of the guide blades, adjacent to the respective flow path boundary. In particular, provision may be made whereby the guide blades have a cut-back in the region of the trailing edge and adjacent to the radially outer flow path boundary and/or adjacent to the radially inner flow path boundary, such that said guide blades form, in the region of the trailing edge, a partial gap with respect to the adjacent flow path boundary. In this embodiment, partial gaps are thus formed in the region of the trailing edge.

It is however additionally or alternatively also possible for the partial gaps to be formed in the region of the leading edge, that is to say for the guide blades to have a cut-back in the region of the leading edge and adjacent to the radially outer flow path boundary and/or adjacent to the radially inner flow path boundary, such that said guide blades form, in the region of the leading edge, a partial gap with respect to the adjacent flow path boundary.

One design variant in this regard provides for the axes of rotation of the guide blades of the stator to be inclined in combined fashion with respect to the axial direction and in the circumferential direction such that an upper corner point and/or a lower corner point describe, during an adjustment of the stagger angle over the range possible for this, a circular trajectory which is oriented locally perpendicularly with respect to the adjacent flow path boundary. The upper corner point is defined here as the point at which the leading edge and the cut-back at the blade tip or the trailing edge and the cut-back at the blade tip converge. The lower corner point is defined here as the point at which the leading edge and the cut-back at the blade root or the trailing edge and the cut-back at the blade root converge. These are thus the upper and/or lower corner points at the leading edge and/or trailing edge of the guide blades, wherein, as stated, in design variants of the invention, partial gaps are formed only in the region of the trailing edge, and, for this situation, the corresponding corner points are self-evidently also formed only at the trailing edge.

By orientation of the axes of rotation such that the trajectory of at least one corner point is oriented in each case locally perpendicularly with respect to the adjacent flow path boundary, the circular trajectory has a substantially constant spacing to the adjacent flow path boundary in the case of every setting of the stagger angle. It is thus achieved that the spacing of a corner point to the adjacent flow path boundary is substantially constant in the case of every set stagger angle.

In one exemplary embodiment of the invention, provision may be made whereby the guide blades are, in order to provide rotatability for the purposes of adjustment of the stagger angle, structurally formed so as to be connected rotationally conjointly to, or formed as a single piece with, a spindle. Provision may be made here whereby the guide blades are connected at their radially outer end in each case to an outer circular platform, also referred to as rotary plate, which is arranged, via the spindle, in the radially outer flow path boundary. The fastening in the radially outer flow path boundary is realized for example by means of a casing shroud.

Provision may furthermore be made whereby the guide blades are connected at their radially inner end in each case to an inner circular platform which is arranged, via the spindle, in the radially inner flow path boundary. The fastening to the radially inner flow path boundary is realized for example by means of an inner shroud, which is arranged in the radially inner flow path boundary. Provision may alternatively be made whereby the guide blades are, at their radially inner end, formed without a shroud, for which case they form a gap with respect to the inner flow path boundary over their entire length (also referred to as “cantilever” design).

In a further aspect of the invention, the invention relates to a gas turbine engine, in particular for an aircraft, having a structural subassembly according to the invention. Provision may be made here whereby the gas turbine engine has:
an engine core which comprises a turbine, a compressor having a structural subassembly according to the invention, and a turbine shaft which is configured as a hollow shaft and connects the turbine to the compressor;
a fan which is positioned upstream of the engine core, wherein the fan comprises a plurality of fan blades; and
a gearbox that receives an input from the turbine shaft and outputs drive for the fan so as to drive the fan at a lower rotational speed than the turbine shaft.

One design embodiment in this regard may provide that
the turbine is a first turbine, the compressor is a first compressor, and the turbine shaft is a first turbine shaft;
the engine core further comprises a second turbine, a second compressor, and a second turbine shaft which connects the second turbine to the second compressor; and
the second turbine, the second compressor, and the second turbine shaft are arranged so as to rotate at a higher rotational speed than the first turbine shaft.

It is pointed out that the present invention, to the extent that the latter relates to an aircraft engine, is described with reference to a cylindrical coordinate system which has the coordinates x, r, and φ. Here, x indicates the axial direction, r indicates the radial direction, and φ indicates the angle in the circumferential direction. The axial direction is in this case identical to the machine axis of a gas turbine engine in which the structural subassembly is arranged. Proceeding from the x-axis, the radial direction points radially outward. Terms such as “in front of”, “behind”, “front”, and “rear” refer to the axial direction, or the flow direction in the engine. Terms such as “outer” or “inner” refer to the radial direction.

As noted elsewhere herein, the present disclosure may relate to a gas turbine engine. Such a gas turbine engine may comprise an engine core which comprises a turbine, a combustion chamber, a compressor, and a core shaft that connects the turbine to the compressor. Such a gas turbine engine may comprise a fan (having fan blades) which is positioned upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive for the fan so as to drive the fan at a lower rotational speed than the core shaft. The input to the gearbox may be performed directly from the core shaft or indirectly from the core shaft, for example via a spur shaft and/or a spur gear. The core shaft may be rigidly connected to the turbine and the compressor, such that the turbine and the compressor rotate at the same rotational speed (wherein the fan rotates at a lower rotational speed).

The gas turbine engine as described and/or claimed herein may have any suitable general architecture. For example, the gas turbine engine may have any desired number of shafts, for example one, two or three shafts, that connect turbines and compressors. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft which connects the second turbine to the second compressor. The second turbine, the second compressor, and the second core shaft may be arranged so as to rotate at a higher rotational speed than the first core shaft.

In such an arrangement, the second compressor may be positioned so as to be axially downstream of the first compressor. The second compressor may be arranged so as to receive (for example directly receive, for example via a generally annular duct) flow from the first compressor.

The gearbox may be arranged so as to be driven by the core shaft (for example the first core shaft in the example above) that is configured to rotate (for example during use) at the lowest rotational speed. For example, the gearbox may be arranged so as to be driven only by the core shaft (for example only by the first core shaft, and not the second core shaft, in the example above) that is configured to rotate (for example during use) at the lowest rotational speed. Alternatively thereto, the gearbox may be arranged so as to be driven by one or a plurality of shafts, for example the first and/or the second shaft in the example above.

In the case of a gas turbine engine as described and/or claimed herein, a combustion chamber may be provided axially downstream of the fan and of the compressor(s). For example, the combustion chamber may lie directly downstream of the second compressor (for example at the exit of the latter), when a second compressor is provided. By way of a further example, the flow at the exit of the compressor may be fed to the inlet of the second turbine, when a second turbine is provided. The combustion chamber may be provided upstream of the turbine(s).

The or each compressor (for example the first compressor and the second compressor as described above) may comprise any number of stages, for example multiple stages. Each stage may comprise a row of rotor blades and a row of stator blades, which may be variable stator blades (in the sense that the angle of incidence of said variable stator blades may be variable). The row of rotor blades and the row of stator blades may be axially offset from one another.

The or each turbine (for example the first turbine and the second turbine as described above) may comprise any number of stages, for example multiple stages. Each stage may comprise a row of rotor blades and a row of stator blades. The row of rotor blades and the row of stator blades may be axially offset from one another.

Each fan blade can be defined as having a radial span extending from a root (or a hub) at a radially inner location flowed over by gas, or at a 0% span width position, to a tip at a 100% span width position. The ratio of the radius of the fan blade at the hub to the radius of the fan blade at the tip may be less than (or of the order of magnitude of): 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in an inclusive range delimited by two of the values in the previous sentence (that is to say that the values may form upper or lower limits). These ratios can commonly be referred to as the hub-to-tip ratio. The radius at the hub and the radius at the tip can both be measured at the leading periphery (or the axially frontmost periphery) of the blade. The hub-to-tip ratio refers, of course, to that portion of the fan blade which is flowed over by gas, that is to say the portion that is situated radially outside any platform.

The radius of the fan can be measured between the engine centerline and the tip of the fan blade at the leading periphery of the latter. The diameter of the fan (which may simply be double the radius of the fan) may be larger than (or of the order of magnitude of): 250 cm (approximately 100 inches), 260 cm, 270 cm (approximately 105 inches), 280 cm (approximately 110 inches), 290 cm (approximately 115 inches), 300 cm (approximately 120 inches), 310 cm, 320 cm (approximately 125 inches), 330 cm (approximately 130 inches), 340 cm (approximately 135 inches), 350 cm, 360 cm (approximately 140 inches), 370 cm (approximately 145 inches), 380 cm (approximately 150 inches), or 390 cm (approximately 155 inches). The fan diameter may be in an inclusive range delimited by two of the values in the previous sentence (that is to say that the values may form upper or lower limits).

The rotational speed of the fan may vary during use. Generally, the rotational speed is lower for fans with a comparatively large diameter. Purely by way of non-limiting example, the rotational speed of the fan under constant-speed conditions may be less than 2500 rpm, for example less than 2300 rpm. Purely by way of a further non-limiting example, the rotational speed of the fan under constant-speed conditions for an engine having a fan diameter in the range from 250 cm to 300 cm (for example 250 cm to 280 cm) may also be in the range from 1700 rpm to 2500 rpm, for example in the range from 1800 rpm to 2300 rpm, for example in the range from 1900 rpm to 2100 rpm. Purely by way of a further non-limiting example, the rotational speed of the fan under constant-speed conditions for an engine having a fan diameter in the range from 320 cm to 380 cm may be in the range from 1200 rpm to 2000 rpm, for example in the range from 1300 rpm to 1800 rpm, for example in the range from 1400 rpm to 1600 rpm.

During use of the gas turbine engine, the fan (with associated fan blades) rotates about an axis of rotation. This rotation results in the tip of the fan blade moving with a speed Uₜᵢₚ. The work done by the fan blades on the flow results in an enthalpy rise dH in the flow. A fan tip loading can be defined as dH/Uₜᵢₚ², where dH is the enthalpy rise (for example the 1-D average enthalpy rise) across the fan and Uₜᵢₚ is the (translational) speed of the fan tip, for example at the leading periphery of the tip (which can be defined as the fan tip radius at the leading periphery multiplied by the angular speed). The fan tip loading under constant-speed conditions may be more than (or of the order of magnitude of): 0.3, 0.31, 0.32, 0.33, 0.34, 0.35, 0.36, 0.37, 0.38, 0.39, or 0.4 (wherein all units in this passage are Jkg⁻¹K⁻¹/(ms⁻¹)²). The fan tip loading may be in an inclusive range delimited by two of the values in the previous sentence (that is to say that the values may form upper or lower limits).

Gas turbine engines in accordance with the present disclosure may have any desired bypass ratio, wherein the bypass ratio is defined as the ratio of the mass flow rate of the flow through the bypass duct to the mass flow rate of the flow through the core under constant-speed conditions. In the case of some arrangements, the bypass ratio may be more than (or of the order of magnitude of): 10, 10.5, 11, 11.5, 12, 12.5, 13, 13.5, 14, 14.5, 15, 15.5, 16, 16.5, or 17. The bypass ratio may be in an inclusive range delimited by two of the values in the previous sentence (that is to say that the values may form upper or lower limits). The bypass duct may be substantially annular. The bypass duct may be situated radially outside the engine core. The radially outer surface of the bypass duct may be defined by an engine nacelle and/or a fan casing.

The overall pressure ratio of a gas turbine engine as described and/or claimed herein can be defined as the ratio of the stagnation pressure upstream of the fan to the stagnation pressure at the exit of the highest pressure compressor (before entry into the combustion chamber). By way of a non-limiting example, the overall pressure ratio of a gas turbine engine as described and/or claimed herein at constant speed may be greater than (or of the order of magnitude of): 35, 40, 45, 50, 55, 60, 65, 70, 75. The overall pressure ratio may be in an inclusive range delimited by two of the values in the previous sentence (that is to say that the values may form upper or lower limits).

The specific thrust of an engine can be defined as the net thrust of the engine divided by the total mass flow through the engine. The specific thrust of an engine as described and/or claimed herein under constant-speed conditions may be less than (or of the order of magnitude of): 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range delimited by two of the values in the previous sentence (that is to say that the values may form upper or lower limits). Such engines can be particularly efficient in comparison with conventional gas turbine engines.

A gas turbine engine as described and/or claimed herein may have any desired maximum thrust. Purely by way of a non-limiting example, a gas turbine as described and/or claimed herein may be capable of generating a maximum thrust of at least (or of the order of magnitude of): 160 kN, 170 kN, 180 kN, 190 kN, 200 kN, 250 kN, 300 kN, 350 kN, 400 kN, 450 kN, 500 kN, or 550 kN. The maximum thrust may be in an inclusive range delimited by two of the values in the previous sentence (that is to say that the values may form upper or lower limits). The thrust referred to above may be the maximum net thrust at standard atmospheric conditions at sea level plus 15 degrees C. (ambient pressure 101.3 kPa, temperature 30 degrees C.) in the case of a static engine. In use, the temperature of the flow at the entry to the high pressure turbine can be particularly high. This temperature, which can be referred to as TET, may be measured at the exit to the combustion chamber, for example directly upstream of the first turbine blade, which in turn can be referred to as a nozzle guide blade. At constant speed, the TET may be at least (or of the order of magnitude of): 1400K, 1450K, 1500K, 1550K, 1600K, or 1650K. The TET at constant speed may be in an inclusive range delimited by two of the values in the previous sentence (that is to say that the values may form upper or lower limits). The maximum TET in the use of the engine can be at least (or of the order of magnitude of), for example: 1700K, 1750K, 1800K, 1850K, 1900K, 1950K, or 2000K. The maximum TET may be in an inclusive range delimited by two of the values in the previous sentence (that is to say that the values may form upper or lower limits). The maximum TET may occur, for example, under a high thrust condition, for example under a maximum take-off thrust (MTO) condition.

A fan blade and/or an airfoil portion of a fan blade described and/or claimed herein may be manufactured from any suitable material or a combination of materials. For example, at least a part of the fan blade and/or of the airfoil may be manufactured at least in part from a composite, for example a metal matrix composite and/or an organic matrix composite, such as carbon fiber. By way of a further example, at least a part of the fan blade and/or of the airfoil may be manufactured at least in part from a metal, such as a titanium-based metal or an aluminum-based material (such as an aluminum-lithium alloy) or a steel-based material. The fan blade may comprise at least two regions which are manufactured using different materials. For example, the fan blade may have a protective leading periphery, which is manufactured using a material that is better able to resist impact (for example of birds, ice, or other material) than the rest of the blade. Such a leading periphery may, for example, be manufactured using titanium or a titanium-based alloy. Thus, purely by way of example, the fan blade may have a carbon-fiber-based or aluminum-based body (such as an aluminum-lithium alloy) with a titanium leading periphery.

A fan as described and/or claimed herein may comprise a central portion, from which the fan blades may extend, for example in a radial direction. The fan blades may be attached to the central portion in any desired manner. For example, each fan blade may comprise a fixing device which can engage with a corresponding slot in the hub (or disk). Purely by way of example, such a fixing device may be in the form of a dovetail that can be inserted into and/or engage with a corresponding slot in the hub/disk in order for the fan blade to be fixed to the hub/disk. By way of a further example, the fan blades may be formed integrally with a central portion. Such an arrangement can be referred to as a blisk or a bling. Any suitable method may be used to manufacture such a blisk or such a bling. For example, at least a part of the fan blades may be machined from a block and/or at least a part of the fan blades may be attached to the hub/disk by welding, such as linear friction welding.

The gas turbine engines described and/or claimed herein may or may not be provided with a variable area nozzle (VAN). Such a variable area nozzle can allow the exit cross section of the bypass duct to be varied during use. The general principles of the present disclosure can apply to engines with or without a VAN.

The fan of a gas turbine as described and/or claimed herein may have any desired number of fan blades, for example 16, 18, 20, or 22 fan blades.

As used herein, constant-speed conditions can mean constant-speed conditions of an aircraft to which the gas turbine engine is attached. Such constant-speed conditions can be conventionally defined as the conditions during the middle part of the flight, for example the conditions experienced by the aircraft and/or the engine between (in terms of time and/or distance) the end of an ascent and the start of a descent.

Purely by way of example, the forward speed under the constant-speed condition can be any point in the range of from Mach 0.7 to 0.9, for example 0.75 to 0.85, for example 0.76 to 0.84, for example 0.77 to 0.83, for example 0.78 to 0.82, for example 0.79 to 0.81, for example of the order of magnitude of Mach 0.8, of the order of magnitude of Mach 0.85 or in the range of from 0.8 to 0.85. Any arbitrary speed within these ranges can be the constant cruise condition. In the case of some aircraft, the constant cruise conditions may be outside these ranges, for example below Mach 0.7 or above Mach 0.9.

Purely by way of example, the constant-speed conditions may correspond to standard atmospheric conditions at an altitude that is in the range from 10,000 m to 15,000 m, for example in the range from 10,000 m to 12,000 m, for example in the range from 10,400 m to 11,600 m (around 38,000 ft), for example in the range from 10,500 m to 11,500 m, for example in the range from 10,600 m to 11,400 m, for example in the range from 10,700 m (around 35,000 ft) to 11,300 m, for example in the range from 10,800 m to 11,200 m, for example in the range from 10,900 m to 11,100 m, for example in the region of 11,000 m. The constant-speed conditions may correspond to standard atmospheric conditions at any given altitude in these ranges.

Purely by way of example, the constant-speed conditions may correspond to the following: a forward Mach number of 0.8; a pressure of 23,000 Pa; and a temperature of −55 degrees C.

As used anywhere herein, “constant speed” or “constant-speed conditions” can mean the aerodynamic design point. Such an aerodynamic design point (or ADP) may correspond to the conditions (including, for example, the Mach number, environmental conditions, and thrust requirement) for which the fan operation is designed. This may mean, for example, the conditions under which the fan (or the gas turbine engine) has the optimum efficiency in terms of construction.

During use, a gas turbine engine described and/or claimed herein may operate at the constant-speed conditions defined elsewhere herein. Such constant-speed conditions may be determined by the constant-speed conditions (for example the conditions during the middle part of the flight) of an aircraft to which at least one (for example 2 or 4) gas turbine engine(s) can be fastened in order to provide the thrust force.

It is self-evident to a person skilled in the art that a feature or parameter described in relation to any one of the above aspects may be applied to any other aspect, unless they are mutually exclusive. Furthermore, any feature or any parameter described here may be applied to any aspect and/or combined with any other feature or parameter described here, unless they are mutually exclusive.

The invention will be explained in more detail below on the basis of a plurality of exemplary embodiments with reference to the figures of the drawing. In the drawing:

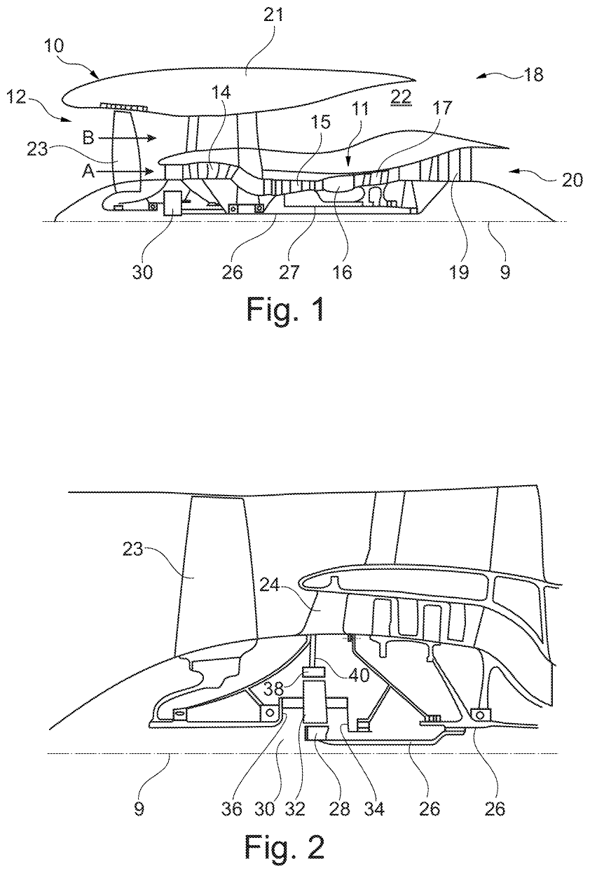

FIG. 1 shows a sectional lateral view of a gas turbine engine;

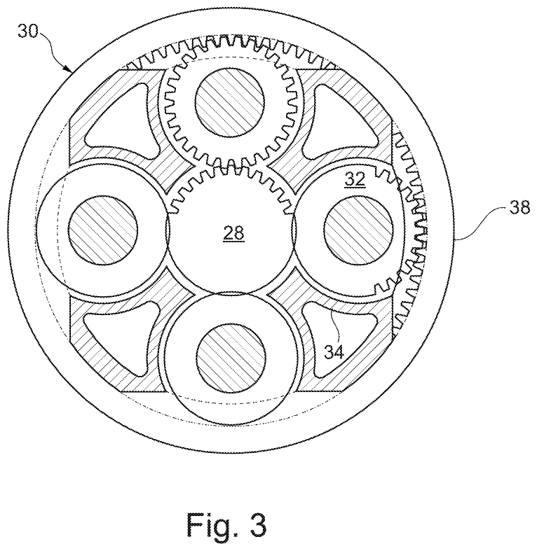

FIG. 2 shows a close-up sectional lateral view of an upstream portion of a gas turbine engine;

FIG. 3 shows a partially cut-away view of a gearbox for a gas turbine engine;

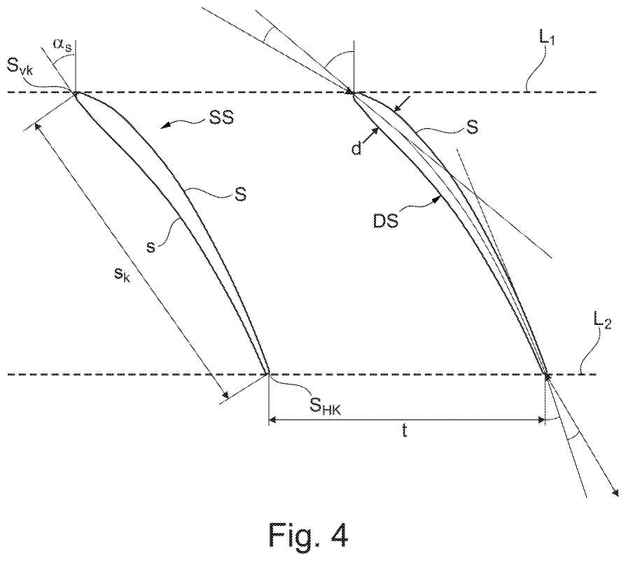

FIG. 4 shows a guide blade cascade, with the stagger angle of the guide blades being illustrated;

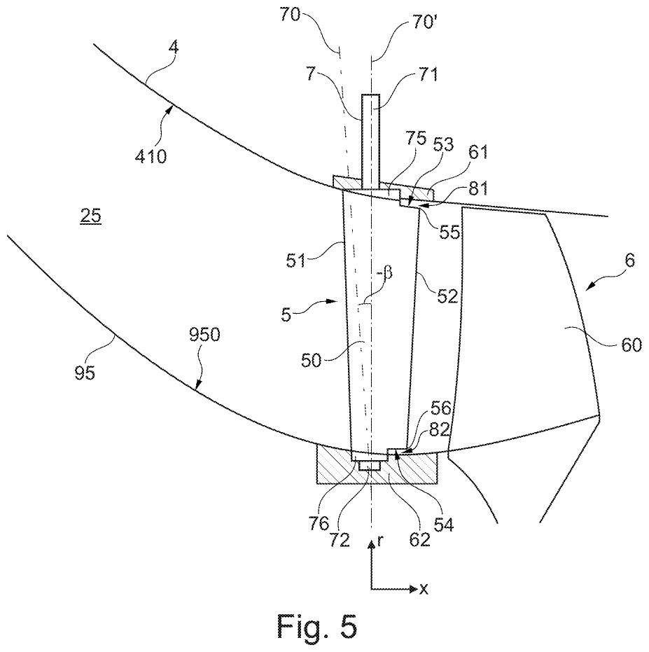

FIG. 5 schematically shows a structural subassembly which has an inlet stator with adjustable stagger angle and partial gaps to the adjacent flow path boundaries;

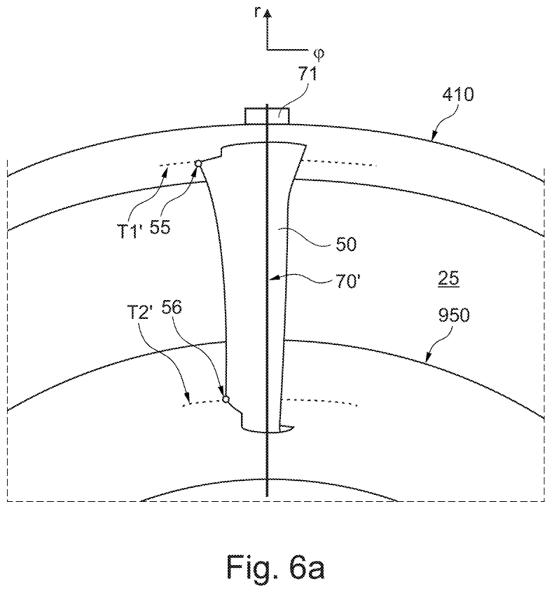

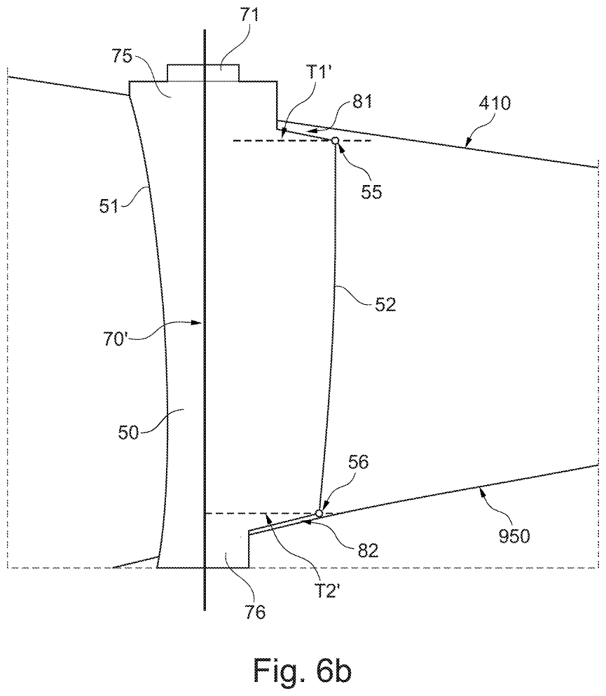

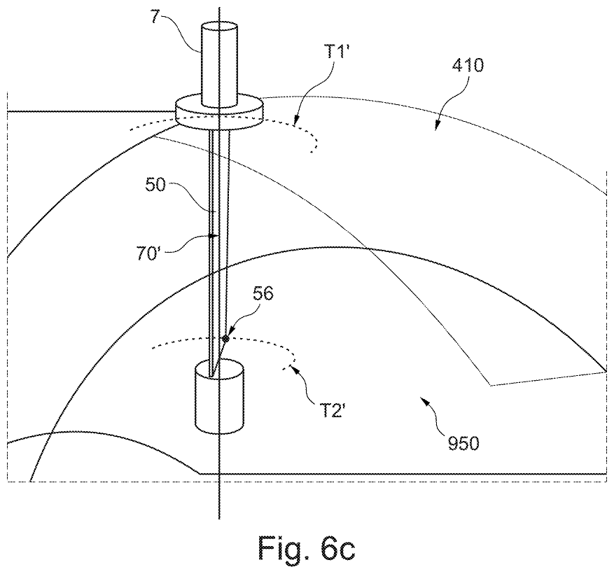

FIGS. 6a-6c show, in a view from the front, in meridional section and in three-dimensional view, a structural subassembly corresponding to FIG. 5, with the trajectory of the trailing-edge corner points during a change of the stagger angle being illustrated;

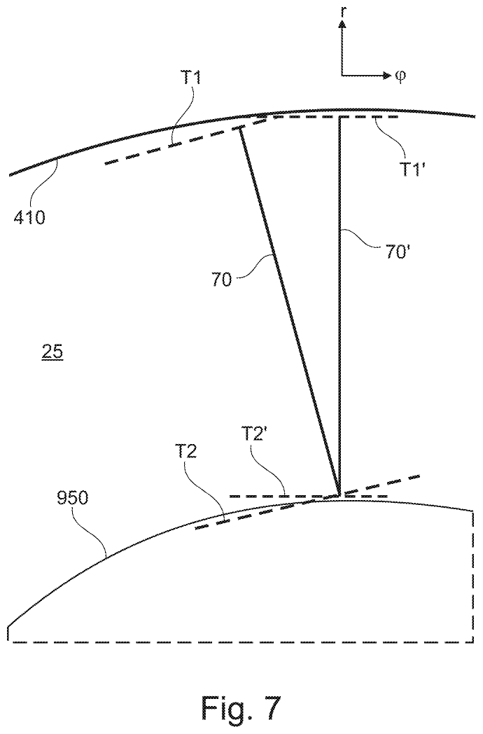

FIG. 7 shows, in a view from the front, an exemplary embodiment of a structural subassembly in which the axis of rotation of the guide blades is arranged so as to be inclined both in an axial direction and in a circumferential direction;

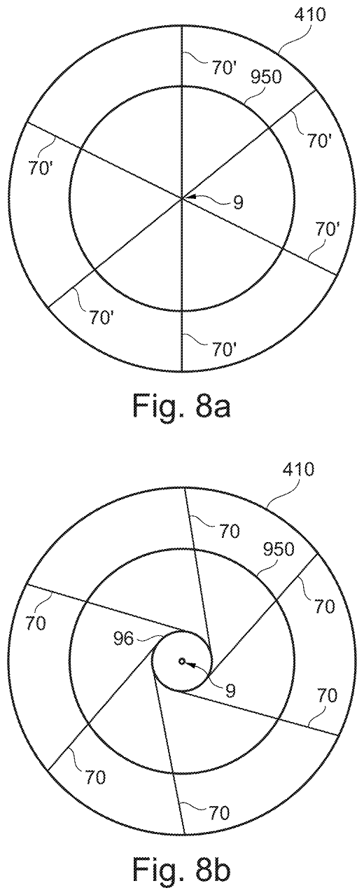

FIG. 8a shows, in a schematic illustration perpendicular to the longitudinal axis of the structural subassembly, the inwardly directed elongations of the axes of rotation of the guide blades of the stator in the case of an exactly radial orientation of the axes of rotation;

FIG. 8b shows, in a schematic illustration perpendicular to the longitudinal axis of the structural subassembly, the inwardly directed elongations of the axes of rotation of the guide blades of the stator in the case of an inclination of the axes of rotation in the circumferential direction, wherein the elongations of the axes of rotation lie tangentially on an imaginary circle; and

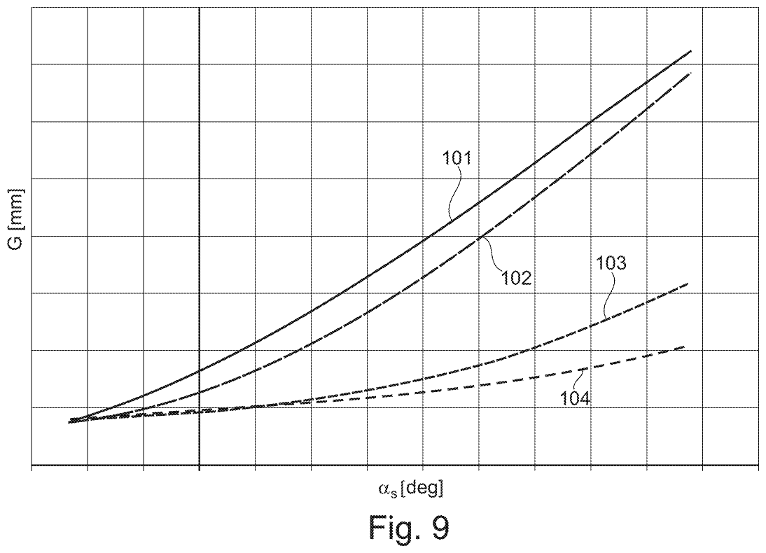

FIG. 9 shows the partial gap in a manner dependent on the stagger angle for a stator with exactly radially oriented guide blades and a stator with guide blades whose axis of rotation is inclined in combined fashion with respect to the axial direction and in the circumferential direction.

FIG. 1 illustrates a gas turbine engine 10 having a main axis of rotation 9. The engine 10 comprises an air intake 12 and a thrust fan 23 that generates two air flows: a core air flow A and a bypass air flow B. The gas turbine engine 10 comprises a core 11 which receives the core air flow A. In the sequence of axial flow, the engine core 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 by way of a shaft 26 and an epicyclic gearbox 30.

During use, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resultant hot combustion products then expand through, and thereby drive, the high-pressure and low-pressure turbines 17, 19 before being expelled through the nozzle 20 to provide some thrust force. The high-pressure turbine 17 drives the high-pressure compressor 15 by means of a suitable connecting shaft 27. The fan 23 generally provides the major part of the thrust force. The epicyclic gearbox 30 is a reduction gearbox.

An exemplary assembly for a gearbox fan gas turbine engine 10 is shown in FIG. 2. The low-pressure turbine 19 (see FIG. 1) drives the shaft 26, which is coupled to a sun gear 28 of the epicyclic gearbox assembly 30. Radially to the outside of the sun gear 28 and meshing therewith are a plurality of planet gears 32 that are coupled to one another by a planet carrier 34. The planet carrier 34 limits the planet gears 32 to orbiting around the sun gear 28 in a synchronous manner while enabling each planet gear 32 to rotate about its own axis. The planet carrier 34 is coupled by way of linkages 36 to the fan 23 so as to drive the rotation of the latter about the engine axis 9. Radially to the outside of the planet gears 32 and meshing therewith is an annulus or ring gear 38 that is coupled, via linkages 40, to a stationary supporting structure 24.

It is noted that the terms “low-pressure turbine” and “low-pressure compressor” as used herein can be taken to mean the lowest-pressure turbine stage and the lowest-pressure compressor stage (that is to say not including the fan 23) respectively and/or the turbine and compressor stages that are connected to one another by the connecting shaft 26 with the lowest rotational speed in the engine (that is to say not including the gearbox output shaft that drives the fan 23). In some literature, the “low-pressure turbine” and “low-pressure compressor” referred to herein may alternatively be known as the “intermediate pressure turbine” and “intermediate-pressure compressor”. Where such alternative nomenclature is used, the fan 23 can be referred to as a first compression stage or lowest-pressure compression stage.

The epicyclic gearbox 30 is shown in an exemplary manner in greater detail in FIG. 3. Each of the sun gear 28, the planet gears 32 and the ring gear 38 comprise teeth about their periphery to mesh with the other gears. However, for clarity, only exemplary portions of the teeth are illustrated in FIG. 3. There are four planet gears 32 illustrated, although it will be apparent to the person skilled in the art that more or fewer planet gears 32 may be provided within the scope of protection of the claimed invention. Practical applications of an epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, wherein the ring gear 38 is fixed. However, any other suitable type of epicyclic gearbox 30 may be used. By way of a further example, the epicyclic gearbox 30 may be a star arrangement, in which the planet carrier 34 is held so as to be fixed, wherein the ring gear (or annulus) 38 is allowed to rotate. In the case of such an arrangement, the fan 23 is driven by the ring gear 38. By way of a further alternative example, the gearbox 30 may be a differential gearbox in which the ring gear 38 and the planet carrier 34 are both allowed to rotate.

It is self-evident that the arrangement shown in FIGS. 2 and 3 is merely an example, and various alternatives fall within the scope of protection of the present disclosure. Purely by way of example, any suitable arrangement may be used for positioning the gearbox 30 in the engine 10 and/or for connecting the gearbox 30 to the engine 10. By way of a further example, the connections (such as the linkages 36, 40 in the example of FIG. 2) between the gearbox 30 and other parts of the engine 10 (such as the input shaft 26, the output shaft and the fixed structure 24) may have a certain degree of stiffness or flexibility. By way of a further example, any suitable arrangement of the bearings between rotating and stationary parts of the engine (for example between the input and output shafts of the gearbox and the fixed structures, such as the gearbox casing) may be used, and the disclosure is not limited to the exemplary arrangement of FIG. 2. For example, where the gearbox 30 has a star arrangement (described above), the person skilled in the art would readily understand that the arrangement of output and support linkages and bearing positions would typically be different to that shown by way of example in FIG. 2.

Accordingly, the present disclosure extends to a gas turbine engine having an arbitrary arrangement of gearbox types (for example star-shaped or planetary), support structures, input and output shaft arrangement, and bearing positions.

Optionally, the gearbox may drive additional and/or alternative components (e.g. the intermediate-pressure compressor and/or a booster compressor).

Other gas turbine engines to which the present disclosure can be applied may have alternative configurations. For example, engines of this type may have an alternative number of compressors and/or turbines and/or an alternative number of connecting shafts. By way of a further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed-flow or split flow) may have a fixed or variable area. While the example described relates to a turbofan engine, the disclosure may be applied, for example, to any type of gas turbine engine, such as an open-rotor engine (in which the fan stage is not surrounded by an engine nacelle) or a turboprop engine. In some arrangements, the gas turbine engine 10 may not comprise a gearbox 30.

The geometry of the gas turbine engine 10, and components thereof, is/are defined by a conventional axis system, comprising an axial direction (which is aligned with the axis of rotation 9), a radial direction (in the bottom-to-top direction in FIG. 1), and a circumferential direction (perpendicular to the view in FIG. 1). The axial, radial and circumferential directions are mutually perpendicular.

In the context of the present invention, the design of stators with a variable stagger angle in the compressor of the gas turbine engine is of importance.

Here, firstly, on the basis of FIG. 4, the basic construction of a guide blade cascade of a stator will be described, and the stagger angle will be defined. The guide blade cascade is illustrated in a conventional illustration in meridional section and in a developed view. Said guide blade cascade comprises a multiplicity of guide blades S, which each have a leading edge S_{VK} and a trailing edge S_{HK}. The leading edges S_{VK} lie on an imaginary line L₁, and the trailing edges S_{HK} lie on an imaginary line L₂. The lines L₁ and L₂ run parallel. The guide blades S furthermore each comprise a suction side SS and a pressure side DS. Their maximum profile thickness is denoted by d.

The guide blade cascade has a cascade pitch t and a profile chord s with a profile chord length sₖ. The profile chord s is the connecting line between the leading edge S_{VK} and the trailing edge S_{HK} of the profile. The blade stagger angle (hereinafter referred to as stagger angle) αₛ is formed between the profile chord s and the perpendicular to the line L₁ (wherein the perpendicular at least approximately corresponds to the direction defined by the machine axis). The stagger angle αₛ indicates the inclination of the blades S.

The invention may be realized on each stator with variable stagger angle. The invention will be discussed below on the basis of an exemplary embodiment, in which said invention is realized on a stator with adjustable guide blades, which is arranged upstream of the first rotor of a compressor. Such a stator is referred to as an inlet stator or pre-stator (IGV—“Inlet Guide Vane”). Inlet stators with variable stagger angle improve the working range of a compressor. The invention may however additionally or alternatively also be realized on any other stator of the compressor which has a variable stagger angle of the guide blades.

Before the invention itself is discussed, the basic construction of a structural subassembly under consideration will firstly be discussed on the basis of FIG. 5.

FIG. 5 shows, in a sectional view, a structural subassembly, which defines a flow path 25 and which comprises an inlet stator 5, a rotor 6 of a compressor stage of a compressor and flow path boundaries. The flow path 25 guides the core air flow A as per FIG. 1 through the core engine.

Radially on the inside, the flow path 25 is delimited by a hub 95, which forms an inner flow path boundary 950. Radially on the outside, the flow path 25 is delimited by a compressor casing 4, which forms a radially outer flow path boundary 410. The flow duct 25 is formed as an annular space. The inlet stator 5 has stator blades or guide blades 50 which are adjustable in terms of stagger angle and which are arranged in the flow duct 25 so as to be distributed in the circumferential direction. The guide blades 50 each have a leading edge 51 and a trailing edge 52.

The swirl in the flow is increased by the inlet stator 5 and, as a result, the downstream rotor 6 is driven more effectively. The rotor 6 comprises a row of rotor blades 60, which extend radially in the flow path 25.

For adjustability of the stagger angle, the guide blades 50 are mounted so as to be rotatable. For this purpose, said guide blades are each connected rotationally conjointly to, or formed integrally with, a spindle 7. The spindle 7 has an axis of rotation 70′, which is identical to the axis of rotation of the guide blades 50. Here, the spindle 7 is accessible and adjustable from outside the flow duct 25.

Specifically, provision is made for the guide blade 50 to be connected at its radially outer end to an outer circular platform 75, which forms a further rotary plate and which is connected to a radially outer spindle portion 71 of the spindle 7. The platform 75 and the spindle portion 71 are in this case mounted in a shroud 61, which is part of the compressor casing 4. Correspondingly, the guide blade 50 is connected at its radially inner end to an inner circular platform 76, which forms a further rotary plate and which is connected to a radially inner spindle portion 72 of the spindle 7. The platform 76 and the spindle portion 72 are in this case mounted in an inner shroud 62, which locally forms the inner flow path boundary 950.

To permit rotatability of the guide blades 50 or adjustability of the stagger angle, it is necessary for the guide blades to form, in the region of their trailing edge 52 and radially adjacent to the outer flow path boundary 410 and radially adjacent to the inner flow path boundary 950, cut-backs 53, 54 which ensure that the guide blades 50, in their axially rear region, form in each case one partial gap 81 to the radially outer flow path boundary 410 and one partial gap 82 to the radially inner flow path boundary 950. This prevents, during an adjustment of the guide blade 50 by rotation about the axis of rotation 70′, said guide blade colliding with the outer flow path boundary 410 and/or with the inner flow path boundary 950.

The gaps 81, 82 are referred to here as partial gaps because they do not extend over the entire axial length of the guide blades 50.

Provision may alternatively be made whereby the guide blades 50 are formed without a shroud at their radially inner end, for which case they end in freely floating fashion, forming a continuous gap, in a manner radially spaced apart from the inner flow path boundary 950. Provision may also alternatively be made for partial gaps to be formed in the region of the leading edge 51 or both in the region of the leading edge 51 and in the region of the trailing edge 52.

Referring again to FIG. 5, it is furthermore the case that the guide blade 50 forms an upper corner point 55 of the trailing edge 52 and a lower corner point 56 of the trailing edge 52. The upper corner point 55 is defined as the point at which the trailing edge 52 and the cut-back 53 at the blade tip converge. The lower corner point 56 is defined as the point at which the trailing edge 52 and the cut-back 54 at the blade root converge.

FIG. 6a, in a view from the front, FIG. 6b, in meridional section, and FIG. 6c, in a perspective view, show the course of the trajectory of the trailing-edge corner points 55, 56 during an adjustment of the stagger angle. Here, correspondingly to the prior art, the guide blade 50 is oriented in exactly radial orientation in the flow path 25, that is to say the axis of rotation 70′ runs in the radial direction.

The upper corner point 55 defines a first trajectory T1′ during variation of the stagger angle. The lower corner point 56 defines a second trajectory T2′ during variation of the stagger angle. As can be seen from the perspective illustration of FIG. 6c, the trajectories T1′, T2′ are circular. This follows from the fact that a rotation of the corner points 55, 56 about the axis of rotation 70′ occurs.

FIG. 7 shows an exemplary embodiment of the invention in a view from the front, that is to say in a section plane perpendicular to the axial direction or machine axis of the structural subassembly. Provision is made whereby the guide blades of the stator are arranged and formed such that their axes of rotation 70 have a combined inclination both with respect to the axial direction and in the circumferential direction cp. Owing to the illustration from the front, the inclination in the axial direction cannot be seen in FIG. 7. To illustrate this, FIG. 5 illustrates—without the corresponding guide blade—an axis of rotation 70 inclined with respect to the axial direction. The spindle 7, the circular platforms 75, 76 and the shrouds 61, 62 are of correspondingly adapted design. The axis of rotation 70 is, in the exemplary embodiment illustrated in FIG. 5, tilted by the angle −β toward the axial direction, that is to say the axis of rotation 70 assumes the angle −β relative to the radial direction r, wherein the angle β is defined as being positive clockwise.

For better comparison with the prior art, FIG. 7 shows both the trajectories T1, T2 that arise in the case of an axis of rotation 70 inclined correspondingly to the present invention if the upper corner point 55 and the lower corner point 56 are rotated about the axis of rotation 70, and the trajectories T1′, T2′ that arise in the case of an axis of rotation 70′ running in a radial direction correspondingly to the prior art if the upper corner point 55 and the lower corner point 56 are rotated about the axis of rotation 70′.

By means of a combined inclination of the axis of rotation 70 both with respect to the axial direction and in the circumferential direction, it is made possible for the partial gaps 81, 82 (see FIG. 5) to be made narrower. In particular, provision is made here for the axis of rotation 70 of the guide blades in an inclined arrangement to be oriented such that, during adjustment of the stagger angle, the circular trajectory T1, T2 is locally oriented perpendicular to the adjacent flow path boundary 410, 950. In this way, the spacing of the respective corner point 55, 56 to the adjacent flow path boundary 410, 950 is substantially constant in the case of every set stagger angle. Variations of the influencing of the flow by the partial gaps 81, 82 in a manner dependent on the set stagger angle are thus avoided.

It is pointed out that the inclination may exist in the circumferential direction (+φ) or counter to the circumferential direction (−φ), wherein the circumferential direction is defined by the clockwise direction. The angle of inclination lies for example in the range between 0 and ±10°.

The inclination in the axial direction may be upstream (−β) or downstream (+β), see FIG. 5, wherein the angle β relative to the exactly radial direction r is defined as being positive clockwise. In this case, too, the angle of inclination lies for example in the range between 0 and ±10°.

FIGS. 8a and 8b illustrate the different orientation of the axis of rotation 70, 70′ of the guide blades in the case of an arrangement according to the prior art (FIG. 8a) and in the case of an arrangement according to the invention (FIG. 8b). In the case of an arrangement according to the prior art, when the axes of rotation 70′ run in the exactly radial direction, the radially inwardly directed elongations of the axes of rotation 70′ intersect at a point which lies on the stator axis, which is identical to the machine axis 9 of the aircraft engine in which the structural subassembly is formed (see FIGS. 1 and 2). In other words, the axes of rotation 70′ are, in the radially inward direction, aligned toward one point.

By contrast, in the case of an inclination of the axes of rotation 70 in the circumferential direction, it is the case that, correspondingly to FIG. 8b, the radially inwardly directed elongations of the axis of rotation 70 are not aligned toward one point, but rather lie tangentially on an imaginary circle 96, which extends circularly around the machine axis 9 in a section plane perpendicular to the stator axis or machine axis 9.

This course, illustrated in FIG. 8b, of the elongations of the axis of rotation 70 is based on the inclination of the axis of rotation 70 in the circumferential direction φ. The inclination that is likewise present with respect to the axial direction does not play a role in this respect.

FIG. 9 illustrates the advantages associated with the structural subassembly according to the invention. FIG. 9 illustrates the radial width G of the partial gaps 81, 82 in a manner dependent on the stagger angle αₛ. The curve 101 shows the thickness of the partial gap 82 at the radially inner flow path boundary for guide blades whose axis of rotation is formed so as to be inclined exclusively in the axial direction. The curve 102 shows the thickness of the partial gap at the radially inner flow path boundary for guide blades whose axis of rotation is formed so as to be inclined in combined fashion with respect to the axial direction and in the circumferential direction. The curve 103 shows the thickness of the partial gap 81 at the radially outer flow path boundary for guide blades whose axis of rotation is formed so as to be inclined exclusively in the axial direction. The curve 104 shows the thickness of the partial gap 81 at the radially outer flow path boundary for guide blades whose axis of rotation is formed so as to be inclined in combined fashion in the axial direction and in the circumferential direction.

It can be seen in each case that, in the case of an orientation of the axis of rotation of the guide blades with a combined inclination both with respect to the axial direction and in the circumferential direction, the partial gaps that arise are reduced. The associated reduced gap leakage reduces the flow losses, leading to an increase in efficiency. At the same time, the disadvantages of the stators are less pronounced, which results in reduced excitation of vibrations of the rotors arranged downstream.

It is self-evident that the invention is not restricted to the embodiments described above and that various modifications and improvements can be made without departing from the concepts described here. It is also pointed out that any of the features described may be used separately or in combination with any other features, unless they are mutually exclusive. The disclosure also extends to and comprises all combinations and sub-combinations of one or a plurality of features which are described here. If ranges are defined, said ranges thus comprise all of the values within said ranges as well as all of the partial ranges that lie in a range.

1. A structural subassembly for a compressor of a turbomachine, which has:
a stator with a multiplicity of guide blades which extend in a flow path of the turbomachine, wherein the guide blades have an axis of rotation and are designed to be adjustable in terms of their stagger angle,
an inner flow path boundary, which delimits the flow path through the turbomachine radially at the inside, and
an outer flow path boundary, which delimits the flow path through the turbomachine radially at the outside,
wherein the guide blades have first partial gaps with respect to the outer flow path boundary and/or second partial gaps with respect to the inner flow path boundary,
wherein
in that the guide blades are arranged and formed such that the axes of rotation of the guide blades have a combined inclination both with respect to the axial direction and in a circumferential direction.

2. The structural subassembly according to claim 1, wherein the axes of rotation of the guide blades of the stator are inclined in the circumferential direction such that the respective radially inwardly directed elongations thereof do not intersect at a point of the stator axis.

3. The structural subassembly according to claim 2, wherein the axes of rotation of the guide blades of the stator are inclined in the circumferential direction such that the respective radially inwardly directed elongations thereof lie tangentially on a circle which extends around the stator axis in a section plane perpendicular to the stator axis.

4. The structural subassembly according to claim 1, wherein the inclination of the axes of rotation of the guide blades both with respect to the axial direction and in the circumferential direction is optimized such that a predefined minimum gap is not undershot in the first partial gap and/or in the second partial gap in the case of all settable stagger angles.

5. The structural subassembly according to claim 4, wherein the inclination of the axes of rotation of the guide blades both with respect to the axial direction and in the circumferential direction is optimized such that the first partial gap and/or the second partial gap maintains a minimum spacing to the adjacent flow path boundary in the case of all settable stagger angles.

6. The structural subassembly according to claim 1, wherein the axes of rotation are inclined in a positive direction in the circumferential direction.

7. The structural subassembly according to claim 1, wherein the axes of rotation are inclined in a negative direction in the circumferential direction.

8. The structural subassembly according to claim 1, wherein the axes of rotation are tilted in the circumferential direction by a tilt angle in the range between 0° and ±10°.

9. The structural subassembly according to claim 1, wherein the axes of rotation are inclined upstream with respect to the axial direction.

10. The structural subassembly according to claim 1, wherein the axes of rotation are inclined downstream with respect to the axial direction.

11. The structural subassembly according to claim 1, wherein the axes of rotation are tilted relative to the axial direction by a tilt angle in the range between 0° and ±10°.

12. The structural subassembly according to claim 1, wherein the partial gaps are formed in the region of the leading edge and/or in the region of the trailing edge of the guide blades, adjacent to the respective flow path boundary.

13. The structural subassembly according to claim 1, wherein the guide blades have a cut-back in the region of the trailing edge and adjacent to the radially outer flow path boundary and/or adjacent to the radially inner flow path boundary, such that said guide blades form, in the region of the trailing edge, a partial gap with respect to the adjacent flow path boundary.

14. The structural subassembly according to claim 1, wherein the guide blades have a cut-back in the region of the leading edge and adjacent to the radially outer flow path boundary and/or adjacent to the radially inner flow path boundary, such that said guide blades form, in the region of the leading edge, a partial gap with respect to the adjacent flow path boundary.

15. The structural subassembly according to claim 13, wherein the axes of rotation of the guide blades of the stator in the circumferential direction are inclined in combined fashion both with respect to the axial direction and in the circumferential direction such that the upper corner point, at which the leading edge and the cut-back at the blade tip or the trailing edge and the cut-back at the blade tip converge, and/or the lower corner point, at which the leading edge and the cut-back at the blade root or the trailing edge and the cut-back at the blade root converge, describe, during an adjustment of the stagger angle, a circular trajectory which is oriented locally perpendicularly with respect to the adjacent flow path boundary.

16. The structural subassembly according to claim 15, wherein the spacing of a corner point to the adjacent flow path boundary is substantially constant in the case of every set stagger angle.

17. The structural subassembly according to claim 1, wherein the guide blades are, in order to provide rotatability for the adjustment of the stagger angle, connected rotationally conjointly to, or formed as a single piece with, a spindle.

18. The structural subassembly according to claim 1, wherein the guide blades are connected at their radially outer end in each case to an outer circular platform which is arranged in the radially outer flow path boundary.

19. A gas turbine engine having a structural subassembly according to claim 1.

20. A gas turbine engine according to claim 19, said gas turbine engine having:
an engine core which comprises a turbine, a compressor having a structural subassembly, and a turbine shaft which is configured as a hollow shaft and connects the turbine to the compressor;
a fan, which is positioned upstream of the engine core, wherein the fan comprises a plurality of fan blades; and
a gearbox that receives an input from the turbine shaft and outputs drive for the fan so as to drive the fan at a lower rotational speed than the turbine shaft.
